(19) United States
(12) Patent Application Publication
(10) Pub. No.: US 2014/0063688 A1
(43) Pub. Date: Mar. 6, 2014

(54) CAPACITOR MODULE

(71) Applicant: Takatomo SASAKI, Toyota-shi (JP)

(72) Inventor: Takatomo SASAKI, Toyota-shi (JP)

(73) Assignees: KOJIMA PRESS INDUSTRY CO., LTD., Toyota-shi (JP); TOYOTA JIDOSHA KABUSHIKI KAISHA, Toyota-shi (JP)

(21) Appl. No.: 14/016,600

(22) Filed: Sep. 3, 2013

(30) Foreign Application Priority Data
Sep. 6, 2012 (JP) 2012-195741

(51) Int. Cl. H01G 4/38

(52) U.S. Cl. CPC H01G 4/385
USPC 361/308.1

(57) ABSTRACT

A capacitor module includes a first film capacitor, a second film capacitor, and a bus bar. The first film capacitor has electrodes at both ends thereof. The second film capacitor has electrodes at both ends thereof A lateral face of the second film capacitor is provided adjacent to a lateral face of the first film capacitor. The bus bar electrically connects the first film capacitor and the second film capacitor to an external device. The bus bar is connected to the electrodes on one end side of the first film capacitor and the second film capacitor. The bus bar is extended to the other end side through a gap between the first film capacitor and the second film capacitor.

### INCORPORATION BY REFERENCE

The disclosure of Japanese Patent Application No. 2012-195741 filed on Sep. 6, 2012 including the specification, drawings and abstract is incorporated herein by reference in its entirety.

### BACKGROUND OF THE INVENTION

1. Field of the Invention

The invention relates to a capacitor module that includes a plurality of film capacitors.

2. Description of Related Art

In the case where a large-capacity capacitor is needed, a large capacity may be realized by connecting a plurality of capacitors in parallel to one another. In the present specification, a unit that is configured by connecting a plurality of capacitors in parallel to one another is referred to as a capacitor module. For example, a large capacity is required of a capacitor that is employed in an electric power system of an electric vehicle, and hence a capacitor module is adopted. Incidentally, a film, capacitor is typically employed as the capacitor.

A large-capacity film capacitor generates a large amount of heat, and hence demands an art for diffusing heat. For example, in Japanese Patent Application Publication No. 2012-009499 (JP-2012-009499 A), there is disclosed an art concerning a capacitor module having a capacitor that is configured by winding a film around a core assuming the shape of a hollow quadratic prism. In this art, an end of the core is connected to a case, and heat inside the capacitor is diffused to the case through the core.

By the way, in order to cause a large current to flow, a long thin sheet-like metal member with a low electric resistance may be employed as a conductor, instead of a soft conductor such as a wire or the like. Such a long thin sheet-like metal member is generally called “a bus bar”. A bus bar may also be employed in a large-capacity capacitor module. The long thin sheet-like metal bus bar is high in thermal conductivity. Therefore, there has been proposed an art of utilizing a bus bar as a heat diffusion path (e.g., Japanese Patent Application Publication No. 2008-311252 (JP-2008-311252 A)).

A capacitor module disclosed in Japanese Patent Application Publication No. 2008-311252 (JP-2008-311252 A) has a capacitor with a core around which a film is wound, and is equipped with a structure of thermally connecting a bus bar to the core. Heat generated inside the capacitor is diffused to the outside of the capacitor through the core and the bus bar.

Apart from reduction of the amount of heat generation, there is also a problem in that the inductance of the capacitor is preferred to be small. The present specification provides an art of reducing the inductance of the capacitor through the use of the bus bar.

### SUMMARY OF THE INVENTION

One embodiment of a capacitor module disclosed by the present specification is equipped with two adjacent film capacitors, and a bus bar that electrically connects the film capacitors to an external device. Each of the two film capacitors is equipped with electrodes at both ends thereof. The two film capacitors are arranged such that lateral faces thereof are adjacent to each other. It should be noted herein that each of “the lateral faces” means a face between the electrodes at both the ends. An end of the bus bar is connected to the electrode of each of the film capacitors on one end side thereof. The bus bar extends to the other end side of each of the capacitors, through a gap between the two film capacitors.

Hereinafter, for the sake of simplification of explanation, “the film capacitors” will be referred to simply as “capacitors” in some cases.

In the aforementioned capacitor module, the direction of a current flowing through the bus bar and the direction of a current flowing through inside the capacitors are reverse to each other. Therefore, an induction magnetic field resulting from a change in the current flowing through the capacitors, and an induction magnetic field resulting from a change in the current flowing through the bus bar counterbalance each other, so that the inductance is reduced.

The capacitor module is not absolutely required to have two film capacitors, but may be equipped with three or more film capacitors. It is sufficient that at least two of three or more film capacitors be equipped with a structure with a bus bar as described above. An example of a capacitor module having three or more film capacitors will be described in the detailed description of the invention.

In the aforementioned capacitor module, the bus bar with high heat transfer property extends between the two capacitors. Accordingly, the bus bar also functions as a heat transfer path from which heat of the capacitors is allowed to escape to the outside. Therefore, the capacitor module having the foregoing structure is also excellent in heat dissipation property. From the standpoint of heat dissipation property, the bus bar may be in contact with each of the two film capacitors, between the two film capacitors. Furthermore, the bus bar may be routed in such a manner as to avoid central regions of the film capacitors when the capacitor module is viewed from a lamination direction of the two film capacitors. As a result of adopting such a structure, heat is unlikely to stagnate between the two capacitors.

According to the art disclosed by the present specification, a capacitor module with a reduced inductance can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an exploded perspective view of a capacitor module;

FIG. 2 is a lateral view of the capacitor module;

FIG. 3 is a plan view of the capacitor module as viewed from a lamination direction;

FIGS. 4A, 4B, and 4C are plan views of capacitor modules according to modification examples; and

FIG. 5 is a lateral view of a capacitor module according to the second embodiment of the invention.

### DETAILED DESCRIPTION OF EMBODIMENTS

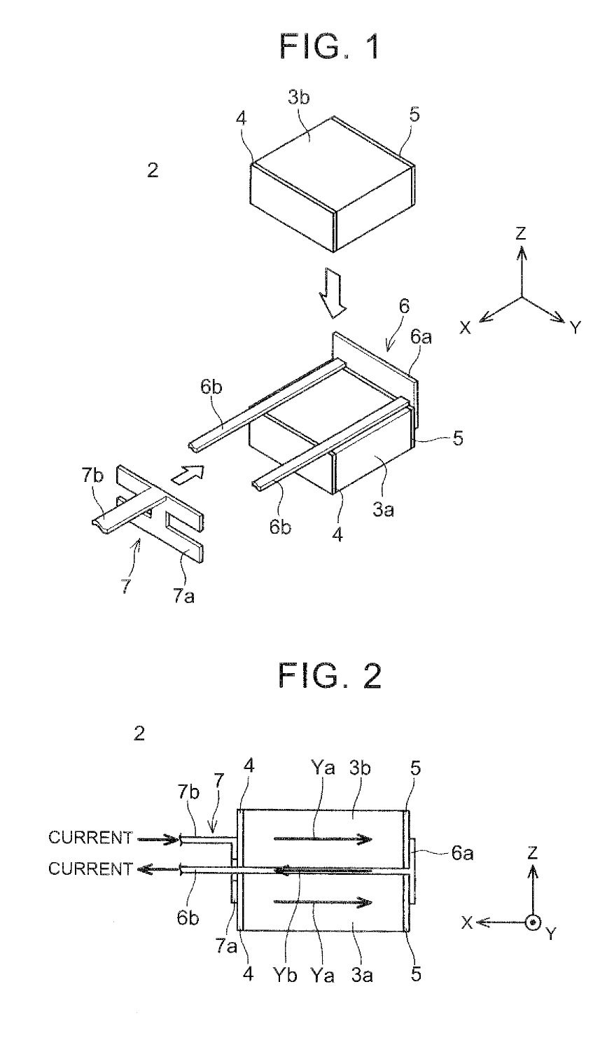

A capacitor module according to each of the embodiments of the invention will be described with reference to the drawings. FIG. 1 is an exploded perspective view showing a capacitor module 2. The capacitor module 2 is a device that is configured by connecting two capacitors (film capacitors) 3a and 3b in parallel to each other. The capacitor module 2 is connected in parallel to an input side of an inverter, for example, in an electric circuit of a motor drive system of an electric vehicle, and smoothens the current. Since the electric circuit of the electric vehicle handles a large current, a large capacity is required of a smoothing capacitor as well. The capacitor module 2 is configured by connecting the plurality of the capacitors 3a and 3b in parallel to each other, and realizes a large capacity.

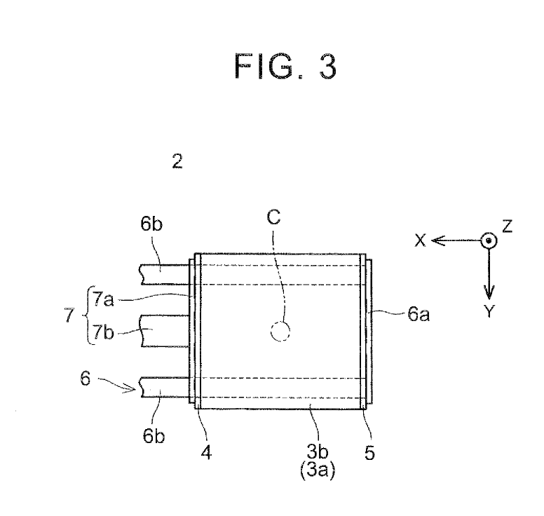

FIG. 2 is a lateral view showing the Capacitor module 2. FIG. 3 is a plan view showing the capacitor module 2. Incidentally, FIG. 3 is a plan view of the capacitor module 2 as viewed from a lamination direction of the two capacitors 3a and 3b (accordingly, in FIG. 3, the capacitor 3b is located below the capacitor 3a).

Each of the capacitors 3a and 3b is a lamination-type film capacitor that is configured by laminating metal films on one another. In FIG. 1, the metal films are laminated on one another in the direction of a Z-axis of a coordination system. Each of the capacitors 3a and 3b is substantially a rectangular parallelepiped, and electrodes 4 and 5 are installed at both ends of the capacitors 3a and 3b respectively in an X-direction in FIG. 1.

The capacitor module 2 is arranged such that the two capacitors 3a and 3b are identical in the orientation of the electrodes, and that lateral faces of the capacitors 3a and 3b are adjacent to each other. A negative electrode bus bar 6 extends between the two adjacent capacitors 3a and 3b. The bus bar is a long thin sheet-like metal conductor for electrically connecting the capacitors 3a and 3b to an external device (e.g., an inverter). The negative electrode bus bar 6 is equipped with a terminal plate 6a that is in contact with the negative electrode 5 located on one end side of each of the capacitors, and conductive portions 6b that extend from the terminal plate 6a. A positive electrode bus bar 7 is connected to the positive electrodes 4 of the capacitors 3a and 3b. The positive electrode bus bar 7 is also equipped with a terminal plate 7a that is in contact with the positive electrodes 4, and a conductive portion 7b that extends from the terminal plate 7a.

As shown in FIG. 2, both ends of the capacitors 3a and 3b are sandwiched by the terminal plate 7a of the positive electrode bus bar 7 and the terminal plate 6a of the negative electrode bus bar 6. The conductive portions 6b of the negative electrode bus bar 6 extend between the capacitors 3a and 3b, from a negative electrode end side of those capacitors toward a positive electrode end side thereof. Incidentally, the negative electrode bus bar 6 is insulated from the positive electrode 4 and the positive electrode bus bar 7. The current is supplied to the positive electrode 4 through the conductive portion 7b and the terminal plate 7a of the positive electrode bus bar 7, passes through inside the capacitors 3a and 3b, and flows from the negative electrode 5 to another device through the terminal plate 6a and the conductive portion 6b of the negative electrode bus bar 6. As shown in FIG. 2, the current flows from the positive electrode 4 toward the negative electrode 5 inside the capacitors 3a and 3b, namely, from the left to the right in FIG. 2. The direction of the current flowing through inside the capacitors is indicated by an arrow Ya. On the other hand, the current flows from the right to the left in FIG. 2, in the conductive portions 6b of the negative electrode bus bar 6 that is sandwiched by the two capacitors 3a and 3b. The direction of the current flowing in the conductive portions 6b is indicated by an arrow Yb in FIG. 2. As indicated by the arrows Ya and Yb, the direction of the current flowing through inside the capacitors and the direction of the current flowing through the negative electrode bus bar 6 (the conductive portions 6b) that extends parallel to the capacitors are reverse to each other. If the current flowing through each of the capacitors 3a and 3b changes, induction magnetic fields are generated around the current. However, since the direction of the current flowing through inside each of the capacitors and the direction of the current flowing through the bus bar (the conductive portions 6b) are reverse to each other, the respective induction magnetic fields are also reverse in direction to each other, and counterbalance each other. The induction magnetic fields constitute a cause of an inductance (an alternating-current resistance component), but counterbalance each other. Therefore, the inductance is reduced in the capacitor module 2. In particular, in the capacitor module 2, the current flowing through the two capacitors 3a and 3b and the current flowing through the negative electrode bus bar 6 (the conductive portions 6b) are equal in magnitude to each other. Therefore, the effect of counterbalancing the induction magnetic fields is great, and the effect of reducing the inductance is great.

As shown in FIGS. 1 and 3, in the negative electrode bus bar 6, the two conductive portions 6b extend from the terminal plate 6a. The two conductive portions 6b are disposed in such a manner as to avoid a central region (an area indicated by a reference symbol C) of each of the capacitors in the plan view of FIG. 3. The conductive portions 6b are in contact with lateral faces of the capacitors 3a and 3b respectively, but a gap corresponding to the thickness of the conductive portions 6b is formed in the area C. When a current is caused to flow through the capacitors, the capacitors generate heat. However, since a void is provided in a central region between the opposed capacitors, heat is restrained from stagnating. Besides, the heat of the capacitors is diffused to the outside of the capacitors through the negative electrode bus bar 6 that is in contact with the capacitors. The negative electrode bus bar 6 that is disposed between the two capacitors 3a and 3b in such a manner as to be in contact with those capacitors also exerts the effect of diffusing the heat of the capacitors.

Incidentally, even a configuration in which a positive electrode bus bar extends between two capacitors instead of a negative electrode bus bar has an induction suppression effect and a heat diffusion effect.

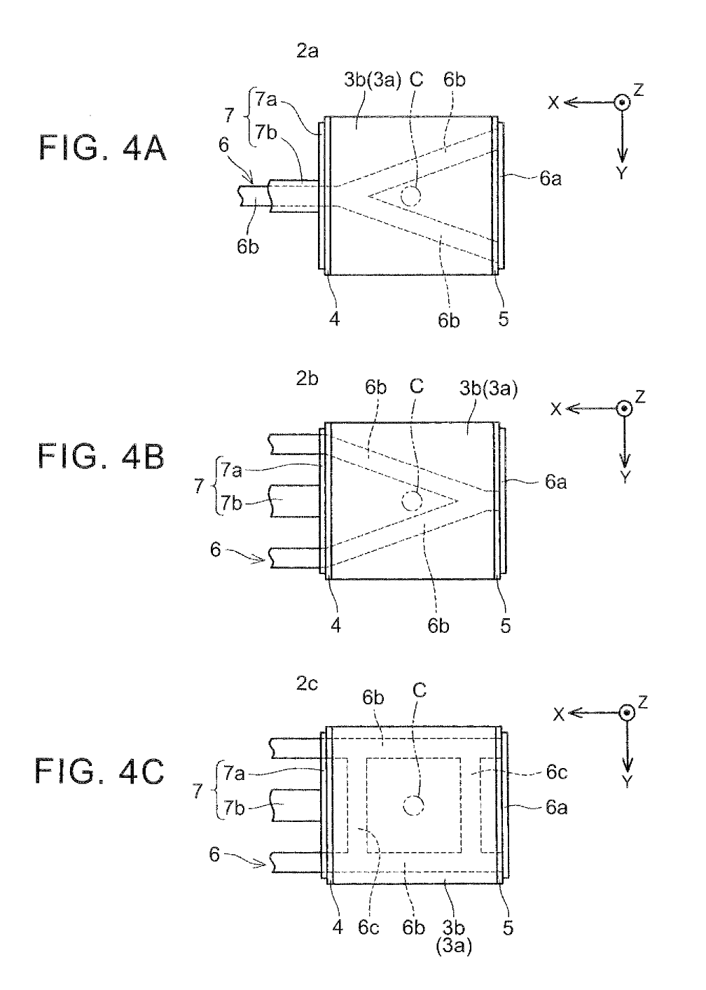

Referring to FIG. 4, modification examples of capacitor modules will be described. FIGS. 4A to 4C are plan views showing capacitor modules 2a, 2b and 2c according to the modification examples. These modification examples are characterized in the layout of the conductive portions 6b of the negative electrode bus bar 6. In the capacitor module 2a shown in FIG. 4A, the two conductive portions 6b extend from the terminal plate 6a that is in contact with the negative electrode 5 of the capacitor 3b (3a), but the, conductive portions 6b merge with each other ahead of the positive electrode 4 that is located on the other side of the capacitor. In the plan view of FIG. 4A, the terminal plate 6a and the two conductive portions 6b form a triangle, but the central region (the region indicated by the reference symbol C) of the capacitor 3b (3a) is located inside the triangle. In this manner, in the capacitor module 2a as well, the conductive portions 6b of the bus bar are routed in such a manner as to avoid the central region C of each of the capacitors in a plan view. Therefore, heat is unlikely to stagnate in the central region C of each of the capacitors.

In the case of the capacitor module 2b shown in FIG. 4B, the single conductive portion 6b extends substantially from the center of the terminal plate 6a and diverges into two conductive portions ahead of the central region C of each of the capacitors in a plan view. The two divergent conductive portions 6b extend from an end opposite each of the capacitors (an end on the positive electrode 4 side) to the outside of each of the capacitors. As shown in FIG. 4B, in this modification example as well, the conductive portions 6b of the bus bar are routed in such a manner as to avoid the central region C of each of the capacitors in a plan view. Therefore, heat is unlikely to stagnate in the central region C of each of the capacitors.

In the case of the capacitor module 2c shown in FIG. 4C, the two conductive portions 6b extend parallel from the terminal plate 6a toward the end opposite each of the capacitors (the end on the positive electrode 4 side). The two conductive portions 6b extend sandwiching the central region C of each of the capacitors 3b (3a) in a plan view. The capacitor module 2c further has reinforcement portions 6c that couple the two conductive portions 6b to each other, but the reinforcement portions 6c also extend in such a manner as to avoid the central region C of each of the capacitors in a plan view. In the case of this capacitor module 2c as well, the conductive portions 6b of the bus bar are routed in such a manner as to avoid the central region C of each of the capacitors in a plan view. Therefore, heat is unlikely to stagnate in the central region C of each of the capacitors.

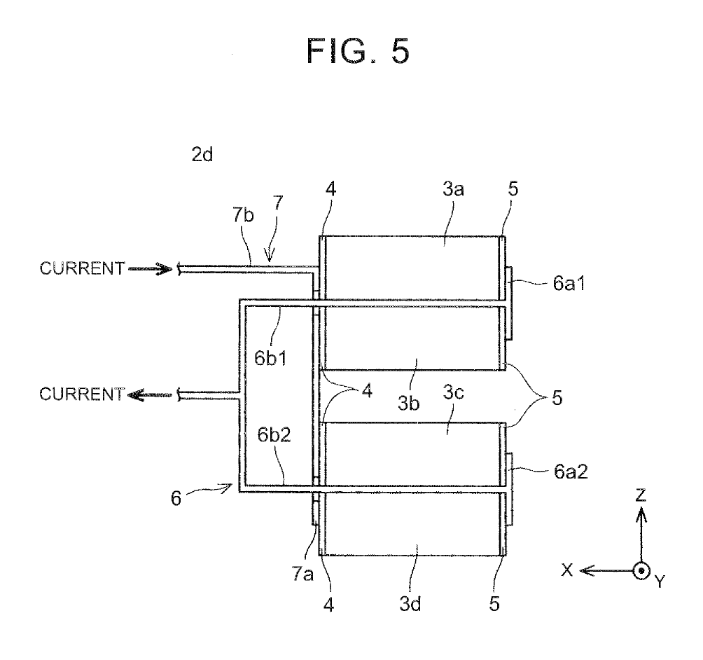

Next, a capacitor module 2d according to the second embodiment of the invention will be described with reference to FIG. 5. This capacitor module 2d has four capacitors, namely, the capacitors 3a and 3b and capacitors 3c and 3d. The four capacitors 3a, 3b, 3c and 3d are connected in parallel to one another by the single negative electrode bus bar 6 and the single positive electrode bus bar 7. The capacitors 3a and 3b are arranged adjacent to each other, and a terminal plate 6a1 is connected to the negative electrodes 5 of those capacitors. A conductive portion 6b1 extends from a center of the terminal plate 6a1. The conductive portion 6b1 extends between the two adjacent capacitors 3a and 3b, toward the positive electrodes 4 that are located on the other side of the negative electrodes 5. Besides, the capacitors 3c and 3d are arranged adjacent to each other, and a terminal plate 6a2 is connected to the negative electrodes 5 of those capacitors. A conductive portion 6b2 extends from a center of the terminal plate 6a2. The conductive portion 6b2 extends between the two adjacent capacitors 3c and 3d, toward the positive electrodes 4 that are located on the other side of the negative electrodes 5. The conductive portions 6b1 and 6b2 eventually converge into one conductive portion. The terminal plates 6a1 and 6a2 and the conductive portions 6b1 and 6b2 constitute the negative electrode bus bar 6. Incidentally, the conductive portions 6b1 and 6b2 of the negative electrode bus bar 6 are insulated from the positive electrodes 4.

The terminal plate 7a is connected to the positive electrodes 4 of the four capacitors 3a, 3b, 3c and 3d, and the conductive portion 7b extends from the terminal plate 7a. The conductive portion 7b and the terminal plate 7a constitute the positive electrode bus bar 7. The current supplied through the positive electrode bus bar 7 is supplied to the positive electrodes 4 of the four capacitors 3a to 3d, and flows through inside the respective capacitors from the left to the right in FIG. 5. The current flows out from the negative electrodes 5 to the negative electrode bus bar 6. In the conductive portions 6b1 and 6b2 of the negative electrode bus bar 6, a current flows from the right to the left in FIG. 5. An induction magnetic field resulting from the current flowing through the two capacitors 3a and 3b is counterbalanced by an induction magnetic field resulting from the current flowing through the conductive portion 6b1 that extends between those capacitors. By the same token, an induction magnetic field resulting from the current flowing through the two capacitors 3c and 3d is counterbalanced by an induction magnetic field resulting from the current flowing through the conductive portion 6b2 that extends between those capacitors. Therefore, in the capacitor module 2d according to the second embodiment of the invention as well, the induction magnetic fields are counterbalanced by each other, and the inductance is suppressed.

Besides, the conductive portion 6b1 of the negative electrode bus bar 6 is in contact with lateral faces of the capacitors 3a and 3b, and the conductive portion 6b2 is in contact with lateral faces of the capacitors 3c and 3d (the negative electrode bus bar 6 is insulated from the lateral faces of the capacitors 3a and 3b, and from the lateral faces of the capacitors 3c and 3d). Heat generated by the capacitors 3a and 3b is diffused to the outside through the conductive portion 6b1. Besides, heat generated by the capacitors 3c and 3d is diffused to the outside through the conductive portion 6b2. In the capacitor module 2d according to the second embodiment of the invention as well, heat generated by the capacitors is likely to be diffused, and the temperature of the capacitors is restrained from rising.

The point to remember about the capacitor module described in each of the embodiments of the invention will be described. In each of the embodiments of the invention, the negative electrode bus bar is connected .to the electrode at one end of each of the capacitors, and extends to the other end side through the gap between the adjacent capacitors. Instead of the negative electrode bus bar, the positive electrode bus bar may be connected to the electrode at one end of each of the capacitors, and extend to the other end side through the gap between the adjacent capacitors. Such a configuration also exerts an inductance suppression effect and a heat diffusion effect.

The concrete examples of the invention have been described above in detail. However, these are nothing more than exemplifications, and do not limit the claims. The art described in the claims encompasses various modifications and alterations of the concrete examples exemplified above. The technical elements described in the present specification or the drawings exert a technical advantage alone or in various combinations, and are not limited to the combinations described in the claims at the time of the filing of the application. Besides, the art exemplified in the present specification or the drawings can achieve a plurality of objects at the same time, and has a technical advantage by achieving one of those objects in itself.

What is claimed is:

1. A capacitor module comprising:
a first film capacitor having electrodes at both ends thereof;
a second film capacitor having electrodes at both ends thereof, a lateral face of the second film capacitor being provided adjacent to a lateral face of the first film capacitor; and
a bus bar electrically connecting the first film capacitor and the second film capacitor to an external device, the bus bar being connected to the electrodes on one end side of the first film capacitor and the second film capacitor, and the bus bar being extended to the other end side through a gap between the first film capacitor and the second film capacitor.

2. The capacitor module according to claim 1, wherein the bus bar is in contact with the first film capacitor and the second film capacitor, between the first film capacitor and the second film capacitor.

3. The capacitor module according to claim 2, wherein the bus bar is routed in such a manner as to avoid central regions of the first film capacitor and the second film capacitor when the capacitor module is viewed from a lamination direction of the first film capacitor and the second film capacitor.
